(19) United States
(12) Patent Application Publication
(10) Pub. No.: US 2011/0284475 A1
(43) Pub. Date: Nov. 24, 2011

(54) Apparatus and Method for Treatment of a Contaminated Water-Based Fluid

(75) Inventor: Yuri KOLODNY, Tel Aviv (IL)

(73) Assignee: KOLMIR WATER TECHNOLOGIES LTD., Jordan Valley (IL)

(21) Appl. No.: 12/947,472

(22) Filed: Nov. 16, 2010

Related U.S. Application Data
(63) Continuation of application No. PCT/IL2009/000492, filed on May 17, 2009.
(60) Provisional application No. 61/056,104, filed on May 27, 2008.

(51) Int. Cl. C02F 1/36

(52) U.S. Cl. 210/748.02; 210/198.1

(57) ABSTRACT

An apparatus and method for controllable separation of a purified fluid from a process water-based fluid containing at least one contaminating component are described. The apparatus comprises a housing having an inlet port for receiving the process water-based fluid through a controllable inlet valve, an outlet port for discharge of the purified fluid and a sludge port for discharge of a sludge fluid. The apparatus also includes an acoustic vibrator configured for generating a controllable acoustic wave having at least one adjustable parameter selected from frequency, amplitude and intensity. This acoustic vibrator creates at least one layer in the process water-based fluid dividing the process water-based fluid into a pre-filtered fluid and a sludge fluid. This layer is substantially perpendicular to a flow direction of said process water-based fluid. The layer comprises hydroxide radicals and oxygen species reacting with the contaminating component thereby transforming the component into radical form and oxidizing the component thereby causing binding of the component into insoluble aggregates which are precipitated within the sludge fluid. In addition, the apparatus comprises a filter unit disposed within the housing in a flow of the pre-filtered fluid from the layer to the outlet port.

### CROSS-REFERENCE TO RELATED APPLICATIONS

This application is a Continuation application of International Application PCT/IL2009/000492 filed on May 17, 2009, which in turn claims priority to U.S. Provisional application 61/056,104 filed on May 27, 2008, both of which are to incorporated herein by reference in their entirety.

### FIELD OF THE INVENTION

This invention relates to a technique for the purification of a contaminated water-based fluid, and more particularly to an apparatus and method for treatment of a contaminated water-based fluid.

### BACKGROUND OF THE INVENTION

A significant amount of research and development has been undertaken in recent years towards environmental clean-up operations, and in particular to the treatment and purification of various fluids. A variety of techniques have been used in prior art to destroy and/or remove from the fluids various contaminating and toxic components, such as oil products, detergents, phenols, dyes, complexons, complexonates, aromatic compounds, unsaturated organic compounds, aldehydes, organic acids, polymers, hydrosols, biological particles, colloidal matter, etc. These techniques generally utilize mechanical, physicochemical and/or biological methods for treatment and purification of the fluids so that the purified fluids can subsequently be returned to the environment. These technologies generally employ various filters and utilize various coagulants, flocculants, oxidants, acids, bases, disinfectants, preservative agents, and deodorants in various combinations to accomplish decontamination or purification of the fluids.

The filtration of suspended particles is usually a very difficult process, due to the strong interactions between the particles and fluid. Conventional filtration can, for example, utilize physical screening techniques (such as mechanical sieves, beds of filtration media, and/or porous filters, in which the water passes through pores with a size smaller than the size of the particles being collected). Moreover, gravity-driven methods are known which accomplish separation the fluid from the suspended particles on the basis of the difference in the densities of the particles and the fluid (such as centrifugal and settling techniques).

One of the disadvantages of porous filters is associated with clogging of the pores of the filter by larger particles which cannot pass through the pores. Moreover, owing to an electric charge, even the particles with sizes smaller than the size of the filter pores can be clogged within the pores, due to the adhesion of the particles to the filter. As a consequence of the clogging, either the flow rate of the fluid has to be gradually increased or a frequent flushing of the filters is necessary. However, increasing the fluid flow rate can push through the filter even larger particles which would not pass through the pores at the original fluid flow rate.

As soon as the filter is clogged, it cannot provide sufficient filtering. As a result, the filtering process can be interrupted, until the filter is cleaned, e.g., by flushing with clean water. These interruptions of the filtering process lead to loss of efficiency of filtering, making the process expensive, and possibly requiring additional components for the filter system.

Various filter systems based on acoustic methods are known for filtrating of contaminated fluids and cleaning filters.

For example, U.S. Pat. No. 6,797,158 issued to Fekke et al. suggests a method and apparatus for acoustically enhanced particle separation. The apparatus uses a chamber through which flows a fluid containing particles to be separated. A porous medium is disposed within the chamber. A transducer mounted on one wall of the chamber is powered to impose on the porous medium an acoustic field that is resonant to the chamber when filled with the fluid. Under the influence of the resonant acoustic field, the porous medium is able to trap particles substantially smaller than the average pore size of the medium. When the acoustic field is deactivated, the flowing fluid flushes the trapped particles from the porous medium and regenerates the medium.

U.S. Pat. Application No. 2004/0188332 issued to Haydock discloses a self-cleaning/self-purging ceramic, telflon-copolymer composite filter which is capable of continuous and/or intermittent cleaning. The filter can be cleaned either continuously or intermittently by ultrasound vibration and/or backpressure within the filter system.

U.S. Pat. No. 7,282,147 issued to Kicker et al. discloses a filtration system with hollow membrane filter elements that is operable to remove relatively high concentrations of solids, particulate and colloidal matter from a process fluid. Acoustic, vibration and ultrasonic energy may be used to clean exterior portions of the hollow membrane filter elements to allow substantially continuous filtration of process fluids.

WO 2007/094666 issued to Dortmans et al. discloses a filter apparatus comprising a product inlet, a filtrate outlet and a porous stiff filter structure. The filter structure separates the product inlet from the filtrate outlet. An ultrasonic actuator is provided that is directly mechanically coupled to the porous stiff filter structure. The actuator is arranged for imparting in-plane vibrational waves to the porous stiff filter structure.

It should be noted that when a filter is interposed to the fluid flow through which the contaminated fluid can pass, the filtrate material of the fluid is retained on the filter and eventually clogs it up.

Acoustic filtering methods based on the use of ultrasonic standing wave fields have also been developed for separation of particles from the water-based fluid without using porous filters. These methods provide the changes in density and/or compressibility of the volume of fluid which contains contaminating particles. These changes of density and/or compressibility can be used for separation of the contaminant particles from the fluid.

In particular, U.S. Pat. No. 4,055,491 issued to Porath-Furedi discloses an apparatus and method that use ultrasonic standing waves for removing microscopic particles from a liquid medium. The apparatus includes an ultrasonic generator propagating ultrasonic waves of over one megahertz through the liquid medium to cause the flocculation of the microscopic particles at spaced points. The ultrasonic waves are propagated in the horizontal direction through the liquid medium, and baffle plates are disposed below the level of propagation of the ultrasonic waves. The baffles are oriented to provide a high resistance to the horizontal propagation therethrough of the ultrasonic waves and a low-resistance to the vertical settling therethrough of the flocculated particles. The ultrasonic generator is periodically energized to flocculate the particles, and then de-energized to permit the settling of the flocculated particles through the baffle plates from whence they are removed.

U.S. Pat. No. 5,626,767 issued to Trampler et al. discloses a multilayered composite resonator system for separation and recycling of particulate material suspended in a fluid by means of an ultrasonic resonance wave. The system includes a transducer, a suspension and a mirror. Acoustic radiation force moves the particles in the liquid towards the nodes or antinodes of the standing wave. Secondary lateral acoustic forces cause them to aggregate and the aggregates settle by gravity out of the liquid.

### GENERAL DESCRIPTION

Despite the prior art in the area of treatment and purification of various fluids, there is still a need in the art for further improvement in order to provide a method and apparatus for effective treatment of water-based fluids from suspended contaminating components, such as oil products, detergents, phenols, dyes, complexons, complexonates, aromatic compounds, unsaturated organic compounds, aldehydes, organic acids, polymers, hydrosols, biological particles and colloidal matter.

It would be advantageous to have a method and apparatus which has a high efficiency of treatment and a deep level of purification.

It would further be useful to have a method and apparatus which is able to reduce consumption of chemicals such as coagulants and flocculants which are commonly utilized for fluid treatment.

It would still further be advantageous to increase the precipitate formation rate, reduce the time and increase the efficiency of removal of non-soluble precipitates from the fluid, when compared to the prior art techniques.

The present invention satisfies the aforementioned need by providing a novel apparatus and method for separation of a purified fluid from a process water-based fluid. The term “process water-based fluid” is broadly used to describe any water-based fluid containing one or more contaminating components. Examples of the process water-based fluid include, but are not limited to, groundwater, surface water, wastewater, industrial effluent, municipal sewage, sewerage, recycled water, tertiary wastewater, landfill leachate, saline water, milk, wine, beer, juice and combinations thereof.

According to one general aspect of the present invention, there is provided an apparatus for a controllable separation of a purified fluid from a process water-based fluid containing at least one contaminating component. The apparatus comprises a housing having an inlet port for receiving the process water-based fluid through a controllable inlet valve, an outlet port for discharge of the purified fluid, and a sludge port for discharge of a sludge fluid.

The apparatus also comprises an acoustic vibrator which is configured for generating a controllable acoustic wave having at least one adjustable parameter selected from frequency, amplitude and intensity. The acoustic wave creates at least one layer in the process water-based fluid thereby dividing the process water-based fluid into a pre-filtered fluid and a sludge fluid. The layer(s) is(are) substantially perpendicular to the flow direction of said process water-based fluid and comprise(s) hydroxide radicals and oxygen species. These hydroxide radicals and oxygen species can react with the contaminating component thereby transforming the component into radical form and oxidizing it. The component radicals bind each other and other contaminating components thus forming insoluble aggregates which are precipitated in the sludge fluid. The apparatus also comprises a filter unit disposed within the housing in a flow of the pre-filtered fluid from the layer to the outlet port.

According to some embodiments of the present invention, this layer features increased second viscosity when compared with the viscosity of the process water-based fluid at the inlet port.

According to some embodiments of the present invention, the acoustic vibrator can be selected from at least one of an ultrasonic energy vibrator and sonic energy vibrator. Preferably, the acoustic vibrator can include a piezo active element.

According to one embodiment of the present invention, the acoustic vibrator can be coupled to the filter unit for vibrating thereof, thereby creating the layer mentioned hereinbefore in the vicinity of the filter unit.

According to another embodiment of the present invention, the acoustic vibrator includes a vibrating membrane mounted in the flow of the process fluid upstream of the filter unit for creating the layer in the vicinity of the vibrating membrane.

According to some embodiments of the present invention, the apparatus has such a configuration as to create a standing acoustic wave within the process water-based fluid.

According to some embodiments of the present invention, a frequency of the acoustic wave is in the range of about 15 kHz to about 300 kHz.

According to some embodiments of the present invention, amplitude of the acoustic wave is in the range of about 1 micrometer to about 10 micrometers.

According to some embodiments of the present invention, an intensity of the acoustic wave is in the range of about 0.1 W/cm² to about 10 W/cm².

According to some embodiments of the present invention, the adjustable parameters selected from frequency, amplitude and intensity of the acoustic wave are selected to provide such activation of oxygen species that a concentration of oxygen molecules in the singlet energy state is about three times greater than the concentration of oxygen molecules in the triplet energy state.

According to one embodiment of the present invention, the apparatus can comprise a flow damper which is disposed in the flow of the process water-based fluid between said inlet port and the filter unit and configured for providing a substantially laminar flow of said process water-based fluid.

According to some embodiments of the present invention, the filter unit includes at least one filter selected from the following: a single media filter, a multi-media filter, a diatomaceous earth filter, a cartridge filter, a membrane filter and a granular filter.

According to some embodiments of the present invention, the apparatus can include a control system which is connected to the inlet valve and to the acoustic vibrator and configured for controlling operation thereof. This control system comprises an inlet sensing assembly and a controller.

The inlet sensing assembly includes at least one sensor which is mounted at the inlet port and configured for measuring one or more inlet electro-chemical characteristics of the process water-based fluid. The inlet electro-chemical characteristics can, for example, be pH, zeta potential, gamma potential, redox potential and electrical conductivity. When desired, the sensor can produce one or more inlet sensor signals indicative of the inlet electro-chemical characteristic.

In addition, this sensor can be configured for measuring one or more inlet chemical characteristics of the process water-based fluid and producing at least one inlet sensor signal indicative of this inlet chemical characteristic(s). The inlet chemical characteristics can, for example, be a total suspended solids (TSS), total organic content (TOC), color index, total hardness, carbonate hardness, oxidizability, iron concentration, dissolved oxygen concentration, ammonia concentration, nitrite concentration, nitrate concentration, alkalinity, fluorine concentration, manganese concentration, silicium concentration, carbon dioxide concentration, sulfate concentration, chloride concentration and dry residue content.

The controller is operatively coupled to the acoustic vibrator and to said at least one sensor and to the inlet valve. Thus, the controller is responsive to the inlet sensor signal and is capable of generating control signals for controlling operation of at least one of the acoustic vibrator and the inlet valve. These parameters and the flow rate downstream of the inlet valve are calculated by using look-up tables for the controllable separation of the purified fluid.

When desired, the control system can comprise an outlet sensing assembly including at least one sensor mounted at the outlet port. This sensor is configured for measuring one or more outlet electro-chemical characteristics of the purified fluid and for producing one or more outlet sensor signals indicative of the outlet electro-chemical characteristics. The outlet electro-chemical characteristic can, for example, be pH, zeta potential, gamma potential, redox potential and electrical conductivity. In addition, this sensor can be configured for measuring one or more outlet chemical characteristics of the purified fluid and for producing one or more outlet sensor signals indicative of the outlet chemical characteristics. The outlet chemical characteristics can, for example, be total suspended solids, total organic content, color index, total hardness, carbonate hardness, oxidizability, iron concentration, dissolved oxygen concentration, ammonia concentration, nitrite concentration, nitrate concentration, alkalinity, fluorine concentration, manganese concentration, silicium concentration, carbon dioxide concentration, sulfate concentration, chloride concentration and dry residue content. The outlet sensing assembly can be operatively coupled to the controller, which is responsive to the outlet sensor signals.

According to some embodiments of the present invention, the apparatus can include one or more control valves adapted for regulating the flow rate at the outlet port. The control valves at the outlet port are responsive to the control signals generated by the control system.

According to another general aspect of the present invention, there is provided a method for controllable separation of a purified fluid from a process water-based fluid containing at least one contaminating component. The method comprises providing an apparatus which includes a housing having an inlet port for receiving the process water-based fluid through a controllable inlet valve arranged at the inlet port and regulating a flow rate of said process water-based fluid, an outlet port for discharge of the purified fluid and a sludge port for discharge of a sludge fluid, a filter unit and an acoustic vibrator.

The method also comprises providing a flow of the process water-based fluid into the housing through said controllable inlet valve and generating an acoustic wave for creating at least one layer in the process water-based fluid thereby dividing the process water-based fluid into a pre-filtered fluid and a sludge fluid. The acoustic wave has at least one adjustable parameter selected from frequency, amplitude, and intensity. The layer is substantially perpendicular to a flow direction of the process water-based fluid and comprises hydroxide radicals and oxygen species reacting with the contaminating component(s), thereby transforming the component into radical form and oxidizing the component. The component radicals bind each other and other contaminating components into insoluble aggregates which are, as a result, precipitated within the sludge fluid that is further discharged from the housing through the sludge port. Accordingly, flow of the pre-filtered fluid is directed through the filter unit in order to obtain the purified fluid downstream of the filter. Further, the purified fluid is discharged from the housing through the outlet port.

According to one embodiment of the present invention, the generating of the acoustic wave includes adjusting at least one adjustable parameter in order to activate the oxygen species such that a concentration of oxygen molecules in the singlet energy state is about three times greater than the concentration of oxygen molecules in the triplet energy state.

According to some embodiments of the present invention, the method comprises creating a substantially laminar flow of the process water-based fluid through the housing.

According to some embodiments of the present invention, the method can also comprise controlling operation of the inlet valve and of the acoustic vibrator. This controlling can include steps of measuring at least one of zeta potential, gamma potential, redox potential and electrical conductivity of the process water-based fluid at the inlet port; calculating one or more adjustable parameters of the controllable acoustic wave and the flow rate downstream of the inlet valve by using look-up tables for the controllable separation of the purified fluid; and regulating the wave parameters and the flow rate of the process water-based fluid downstream of the inlet valve in order to match values of the wave parameters and the flow rate obtained in the calculations. The acoustic wave is produced by the acoustic vibrator and features one or more parameters selected from frequency, amplitude and intensity. In operation, the controlling can include measuring of at least one of an amount of total suspended solids, total organic content, color index, total hardness, carbonate hardness, oxidizability, iron concentration, dissolved oxygen concentration, ammonia concentration, nitrite concentration, nitrate concentration, alkalinity, fluorine concentration, manganese concentration, silicium concentration, carbon dioxide concentration, sulfate concentration, chloride concentration and dry residue content of the process water-based fluid at the inlet port.

According to a further aspect of the present invention, a method for controllable separation of a purified fluid from a process water-based fluid comprises passing the process water-based fluid through at least one layer formed in the process water-based fluid generated by an acoustic wave in order to divide the process water-based fluid into a pre-filtered fluid and a sludge fluid. Further, the pre-filtered fluid is passed through a filter unit to obtain the purified fluid downstream of the filter unit.

The method and apparatus of the present invention have many of the advantages of the techniques mentioned theretofore, while simultaneously overcoming some of the disadvantages normally associated therewith.

In contrast to known acoustic methods for fluid treatment, the method and apparatus of the present invention control the continuity of the chain reaction of radical formation, oxidation and coagulation of the contaminating components. The absence of such control leads to spontaneous breakdown of the radical chain reaction and formation of reactive, highly poisonous and carcinogenic compounds.

The method and apparatus of the present invention purify the treated fluid from low contaminating components whose size can, for example, be about 20 micrometers.

The method and apparatus of the present invention increase the time and exploitation efficiencies of utilized filter units.

The method and apparatus of the present invention allow increasing the flow rate of the process fluid through the filter thereby enhancing the overall process of the fluid purification.

The method and apparatus of the present invention can be applied for disinfection of the process water-based fluid.

The method and apparatus of the present invention are highly economical and operate with minimal losses of energy and chemicals.

The apparatus according to the present invention may be easily and efficiently fabricated and marketed.

The apparatus according to the present invention is of durable and reliable construction.

The apparatus according to the present invention may have a low manufacturing cost.

There has thus been outlined, rather broadly, the more important features of the invention so that the detailed description thereof that follows hereinafter may be better understood, and the present contribution to the art may be better appreciated. Additional details and advantages of the invention will be set forth in the detailed description.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic view of an apparatus for separation of a purified fluid from a process water-based fluid containing contaminating components, according to one embodiment of the present invention;

FIG. 2 is a schematic presentation of the separation mechanism of the purified fluid from a process water-based fluid which takes place in the vicinity of the filter unit of the apparatus shown in FIG. 1;

FIG. 3 is a schematic configuration of an apparatus for separation of a purified fluid from a process water-based fluid containing contaminating components, according to another embodiment of the present invention; and

FIG. 4 is a non-limiting example of a system for separation of the purified fluid from the process water-based fluid utilizing the apparatus of the invention.

### DETAILED DESCRIPTION OF THE PREFERRED EMBODIMENTS

The principles of the method according to the present invention may be better understood with reference to the drawings and the accompanying description, wherein like reference numerals have been used throughout to designate identical elements. It should be understood that these drawings, which are not necessarily to scale, are given for illustrative purposes only, and are not intended to limit the scope of the invention. Examples of constructions and manufacturing processes are provided for selected elements. Those versed in the art should appreciate that many of the examples provided have suitable alternatives which may be utilized.

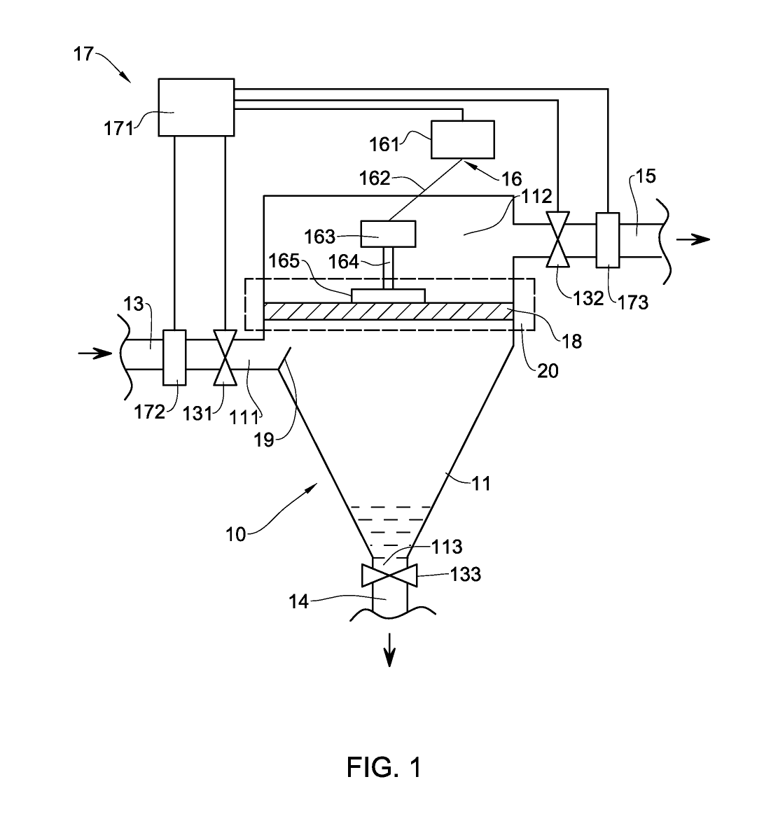

Referring to FIG. 1, there is provided a schematic view of an apparatus 10 for separation of a purified fluid from a process water-based fluid containing one or more contaminating components, according to one embodiment of the present invention. The apparatus 10 includes a housing 11, an acoustic wave vibrator 16 adapted for generating acoustic waves within the process water-based fluid in the housing 11, and a filter unit 18 disposed in the housing 11.

The term “housing” is broadly used to describe any container, tank, chamber, vessel, cartridge, surrounding housing, frame assembly or any other structure that can be used for holding the process water-based fluid during the treatment in accordance with the teaching of the present invention. As illustrated in FIG. 1, the housing 11 has an inlet port 111 for receiving the process water-based fluid therethrough, an outlet port 112 for discharging the purified fluid, and a sludge port 113 for discharging sludge fluid.

In operation, the process water-based fluid flows through an inlet pipe 13, and enters the housing 11 through the inlet port 111. After a separation procedure, as will be described thereinafter, the purified fluid flows out of the housing 11 through the outlet port 112 into an outlet pipe 15. In turn, the sludge fluid is collected from the sludge port 113 and fed into a sludge-collection pipe 14. When desired, the sludge-collection pipe 14 can be associated with a wastewater system (not shown). Accordingly, the sludge can be further dewatered by a filter-press (not shown) arranged downstream of the sludge-collection pipe 14, and after the dewatering, it can be packed and stored.

Preferably, a controllable inlet valve 131, a controllable outlet valve 132 and a controllable sludge valve 133 are disposed in the vicinity of the inlet port 111, the outlet port 112 and the sludge port 112, respectively. The inlet valve 131, the outlet valve 132 and the sludge valve 133 are configured to regulate the flow rate of the process water-based fluid, the purified fluid and the sludge fluid, respectively. The term “valve” as used herein has a broad meaning and relates to any electrical or mechanical device adapted to regulate the flow rate of the fluid.

The acoustic wave vibrator 16 is configured and operable for generating a controllable acoustic wave. According to one embodiment of the present invention, the acoustic wave vibrator 16 includes a generator 161, a transducer 163 coupled to the generator 161 via a connecting line 162, and a vibrating element 165 coupled to the transducer 163 via a transmitting line 164. The vibrating element 165 is associated with the filter unit 18 for vibrating the filter unit in accordance with the operative principle as will be described thereinafter.

According to one embodiment, the generator 161 generates a periodic electrical signal either at ultrasonic or sonic frequencies. The waveform of the signal can, for example, be sinusoidal at frequencies in the range of about 15 kHz to about 300 kHz. Amplitude of the acoustic wave can be in the range of about 1 micrometer to about 10 micrometers, and an intensity of the acoustic wave can be in the range of about 0.1 W/cm² to about 10 W/cm².

It should be understood that the waveform of the electrical signal generated by the generator 161 can generally have any desired shape. Examples of the shape include, but are not limited to, a triangular, square or any other required geometric shape. The signal characteristics can be adjusted manually and/or automatically as will be described hereinafter.

According to one embodiment, the connecting line 162 which couples the transducer 163 to the generator 161 includes a wire. According to another embodiment, this connection can be provided wirelessly, mutatis mutandis. The transducer 163 is configured for transforming electrical energy provided by the generator 161 into mechanical energy. Accordingly, it receives the electrical signal produced by the generator 161 and transforms this signal into corresponding mechanical vibrations, which are transferred to the vibrating element 165 via the transmitting line 164. The transmitting line 164 can, for example, include a stiff or elastic rod attached to the transducer 163 at one end of the rod and to the vibrating element 165 at the other end of the rod. For transferring mechanical vibrations, the rod can perform reciprocal and/or rotating movements.

According to one embodiment, the vibrating element 165 is mechanically attached to the filter unit 18 so as to not restrict the flow of the fluid through the filter unit. In this case, the filter unit 18 can participate in vibrations together with the vibrating element 165 and produce acoustic waves within the process water-based fluid. As will be described thereinbelow, these vibrations can create layers within the fluid that have an increased second viscosity, when compared to the viscosity of the process water-based fluid at the inlet port. These layers are usually formed in the vicinity of the filter unit 18, and include hydroxide radicals and various forms of oxygen that can oxidize the contaminating components, and thereby cause their coagulation. Consequently, the process water-based fluid, after passing through these layers, is divided into pre-filtered fluid and sludge fluid.

According to another embodiment, the vibrating element 165 is arranged in the flow of the process water-based fluid upstream of the filter unit 18 and is not directly attached to the filter unit 18. In this case, the vibrating element 165 includes a vibrating membrane (not shown) configured to create the layers having an increased second viscosity and including hydroxide radicals and various forms of oxygen in the vicinity of this vibrating membrane.

According to a further embodiment, the housing 11 includes a flow damper 19 disposed within the flow of the process water-based fluid downstream of the inlet port 111 to provide a laminar flow of the process water-based fluid. The flow damper 19 can include any flow control unit (not shown) that is configured and operable to produce a substantially laminar flow of the process water-based fluid through the housing. In the simplest case, as shown in FIG. 1, the flow damper 19 can include a plate mounted to the housing and arranged within the fluid flow for dampering the flow. It should be relevant to note here that although the flow of the process water-based fluid on the macroscopic scale level should preferably be a laminar flow, nevertheless, as will be described hereinbelow, this flow should possess a certain turbulence of the flow on the microscopic scale (i.e., ion-scale) level. Such microscopic turbulence within the present application will be referred to as “quasi-turbulence”.

The filter unit 18 is disposed in a flow of the pre-filtered fluid downstream of the layers formed in the fluid by the acoustic wave vibrator 16. The filter unit 18 is configured and operated for filtering and separation of contaminating components in the pre-filtered fluid which are left after passing the process water-based fluid through the layers.

According to the embodiment shown in FIG. 1, the filter unit is a planar filter unit mounted to walls of the housing 11 between the inlet port 111 and the outlet port 112. It should be understood that the filter unit is not limited to any particular implementation. Examples of the filter units include, but are not limited to, one or more filters selected from single media filters, multi-media filters, diatomaceous earth filters, cartridge filters, membrane filters, granular filters, etc. When desired, any combination of the filters of various types can be used.

According to one embodiment of the present invention, the apparatus 10 includes a control system 17 coupled to the acoustic vibrator 16 and the controllable inlet valve 131 and configured for controlling operation thereof. The control system 17 can be set up either automatically or manually to control operation of the acoustic vibrator 16 to provide acoustic signals having desired characteristics and to control operation of the controllable inlet valve 131 to regulate flow rate of the process water-based fluid.

According to one embodiment, the control system 17 includes a controller 171 and an inlet sensing assembly 172 coupled to the controller 171. The inlet sensing assembly 172 includes one or more chemical and/or electro-chemical sensors configured for measuring of chemical and/or electro-chemical properties of the process water-based fluid. Examples of the electro-chemical properties include, but are not limited to, pH, zeta potential, gamma potential, redox potential and electrical conductivity of the fluid.

For the purpose of the present application, the redox potential is the electric potential measured within the process fluid with a reference electrode. When desired, this value can also be calculated on the base of the calculation of a motion of charged particles in the process water-based fluid by using a pH meter or cytopherometer. This technique is known per se and will not be expounded hereinbelow.

In turn, examples of the chemical properties include, but are not limited to, total suspended solids (TSS) concentration, total organic content (TOC), color index, total hardness, carbonate hardness, oxidizability, iron concentration, dissolved oxygen concentration, ammonia concentration, nitrite concentration, nitrate concentration, fluorine concentration, manganese concentration, silicium concentration, carbon dioxide concentration, sulfate concentration, chloride concentration, alkalinity, and dry residue content.

The inlet sensing assembly 172 produces inlet sensor signals indicative of one or more aforementioned fluid properties and relays them to the controller 171 via a wire or wirelessly. The controller 171 is an electronic device that generates control signals to control operation of the acoustic vibrator 16, and, when required, the operation of the inlet valve 131.

According to a further embodiment, the control system 17 includes an outlet sensor assembly 173 installed at the outlet port 112, in order to control the quality of the purified fluid. The outlet sensing assembly 173 includes one or more sensors configured for measuring chemical and/or electro-chemical properties of the purified fluid. These properties can be similar to the properties which are measured by the inlet sensing assembly 172. Accordingly, the outlet sensing assembly 173 measures the properties and produces one or more outlet sensor signals indicative to these properties. These signals are relayed to the controller 171 via electrical wire or wirelessly. In response to the outlet sensor signals, the controller 171 generates corresponding control signals to control operation of the acoustic vibrator 16, and when required to control operation of the inlet valve 131 and/or the outlet valve 132.

Generally, a method for controllable separation of a purified fluid from a process water-based fluid comprises passing the process water-based fluid through at least one layer formed in the process water-based fluid generated by an acoustic wave in order to divide the process water-based fluid into a pre-filtered fluid and a sludge fluid. Further, the pre-filtered fluid is passed through a filter unit to obtain the purified fluid downstream of the filter unit.

Specifically, the process water-based fluid enters the housing 11 of the apparatus 10 through the inlet port 111. The ingress of fluid is controlled by the controllable inlet valve 131 arranged at the inlet port 111. The acoustic vibrator 16 generates adjustable acoustic waves within the process water-based fluid featuring one or more adjustable parameters. Examples of the adjustable parameters include, but are not limited to, the frequency, amplitude, and intensity of the acoustic wave and the time during which the fluid should be exposed to the acoustic wave. It should be noted that the exposing time should preferably be equal or greater than the life-time of hydroxide radicals from their formation till their reaction with contaminating components.

The waveform of the acoustic waves can, for example, be sinusoidal. The frequencies of the wave can be in the range of about 15 kHz to about 300 kHz. Amplitude of the acoustic wave can be in the range of about 1 micrometer to about 10 micrometers, and an intensity of the acoustic wave can be in the range of about 0.1 W/cm² to about 10 W/cm².

Preferably, but not mandatory, the generated acoustic wave is a standing wave. The acoustic waves having the parameters indicated above may propagate substantially perpendicular to a flow direction of the fluid and create one or more layers extending substantially perpendicular to the flow direction. The layers feature an increased second viscosity due to the acoustic vibrations emitted into the water-based process fluid. When entering these layers, the contaminating components react with the radicals and oxygen, thereby transforming the contaminating components into radical and oxidized forms. These radical and oxidized forms react and bind to each other and to other contaminating components, thereby forming insoluble aggregates, which thereafter are precipitated as sludge that can be discharged through the sludge port 113. A concentration of the contaminating particles decreases as long as the flow of the process water-based fluid progresses through the layers towards the filter unit 18. In other words, the layers divide the process water-based fluid into a pre-filtered fluid and a sludge fluid. After passing through the layers, a minor portion of the contaminating components can still be present within the pre-filtered fluid. Accordingly, this portion of the contaminating components can reach the filter unit 18 where the pre-filtered fluid can be further filtered. A purified fluid obtained downstream of the filter unit 18 can be discharged from the housing 11 through the outlet port 112.

It should be noted that acoustic waves generated within fluid containing contaminating particles can generally produce either a favorable or detrimental result. In particular, when the wave parameters are selected arbitrarily and uncontrollably, the acoustic waves may induce uncontrollable cavitation of the fluid that consequently may lead to a hydrodynamic turbulence in the fluid flow. However, the hydrodynamic turbulence can lead to the breakdown of the fluid, and to the dissipation and loss of energy. Likewise, the hydrodynamic turbulence may result in breaking the radical chain reaction taking place within the fluid, and, consequently, in a non-controllable decrease of the concentration of active hydroxide radicals. Such a non-controllable decrease of the concentration of active hydroxide radicals may lead to the formation of reactive, highly poisonous and carcinogenic compounds.

On the other hand, when a ‘quasi-turbulence’ is created in the macroscopically laminar flow of the process fluid by the acoustic waves, the radical chain reaction taking place within the fluid can be completed and a required concentration of active hydroxide radicals will be obtained. A laminar flow with specific distortions within the layers will be referred within the present description to as a ‘quasi-turbulent’ flow. The quasi-turbulence does not have hydrodynamic nature, but rather ion-acoustic nature of the turbulence. Such a quasi-turbulent flow provides a uniform dissipation of the propagated energy in predetermined locations (layers) within the process fluid.

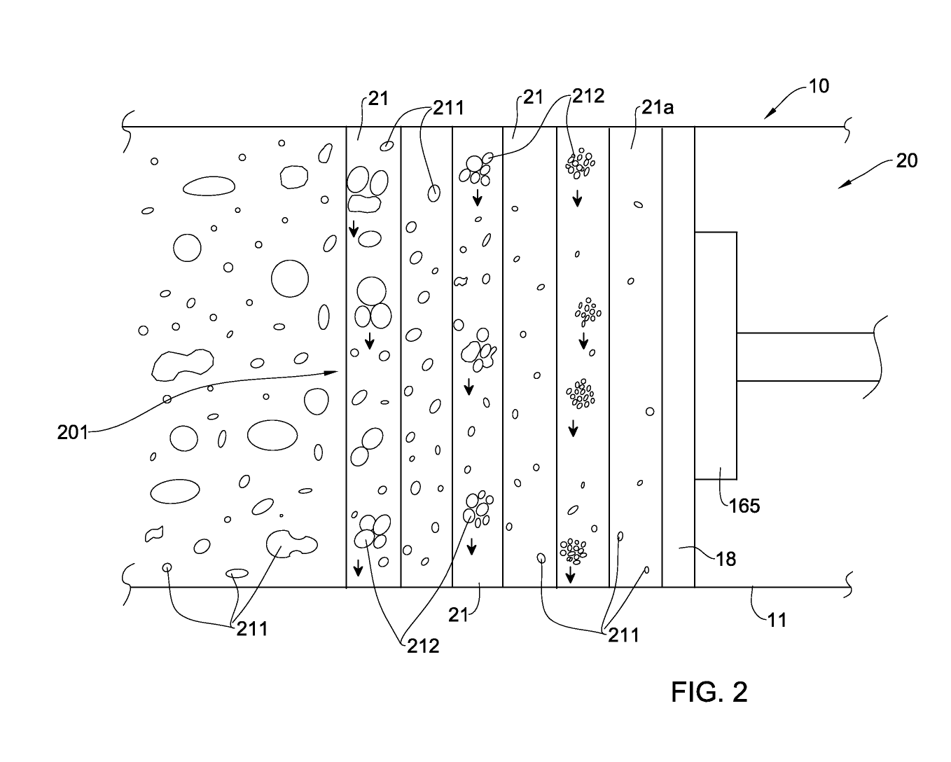

Referring to FIG. 2, an enlarged view of the section indicated in FIG. 1 by reference numeral 20 is illustrated. For convenience of understanding, FIG. 2 shows the separation of the purified fluid from a process water-based fluid in the vicinity of the filter unit 18. The process water-based fluid flows through the housing 11 towards the filter unit 18, in a direction marked by arrows 201. As described, the process water-based fluid contains one or more organic contaminating components 211 suspended in the fluid. Generally, the contaminating components 211 can have various forms, shapes, electrical charges, structures, and other properties. Negatively charged components 211 (herein designated by symbol R⁻) are surrounded by cations, such as hydroxide H₃O⁺, hydron H⁺, etc. In turn, positively charged components 211 (herein designated by symbol R⁺) are surrounded by anions, e.g., OH⁻.

According to the embodiment shown in FIG. 2, the vibration element 165 is attached to the filter unit 18 for generating acoustic waves having predetermined characteristics described above. The acoustic waves concentrate energy in the layers 21 which are formed substantially perpendicular to a flow direction of the process water-based fluid. The layers 21 feature, inter alia, an increased second viscosity when compared to the viscosity of the process water-based fluid at the inlet port. It should be understood that layer 21a that is closest to the filter unit 18 should have the highest second viscosity. The other layers 21 located apart from filter unit 18 have smaller second viscosity value, owing to the decay of the acoustic energy propagating through the fluid from the filter unit 18.

The energy concentrated in the layers 21 should be sufficient to activate the oxygen dissolved in the fluid, and to initiate energetically unstable reactions of the process water-based fluid, and thereby to yield unstable intermediate matters and radicals within the layers. More specifically, the energy concentrated in the layers 21 yields various oxygen species that can be in the following forms: atomic (O), and molecular (O₂ and O₃). O₂ molecules can be formed either in a singlet energy state or in a triplet energy state. It was found by the Applicants that a concentration of oxygen molecules in a singlet energy state should, preferably, be about three times greater than the concentration of oxygen molecules in a triplet energy state. In this case a continuous chain reaction can take place within the layers 21 that controllably provides various hydroxide radicals, such as OH., HO₂. and H₂O₃., which are necessary for oxidation and formation of radicals of contaminating components that can aggregate and precipitate as sludge fluid. The sludge fluid contains aggregates of contaminating components most of which can settle at the bottom of the housing (11 in FIG. 1) under gravity, and thus will not reach the filter unit 18.

More specifically, the hydroxide radicals OH., HO₂. and H₂O₃. can for example be formed as result of the following reactions:

2H₂O+O₂ [symbol] 2H₂O₂ (1)

H₂O [symbol] OH.+H⁺ (2)

2OH. [symbol] HO₂.+H⁺ (3)

OH.+O₃ [symbol] HO₂.+O₂ (4)

HO₂.+H₂O₂ [symbol] OH.+H₂O+O₂ (5)

2HO₂.+O₂ [symbol] 2H₂O₃. (6)

When the contaminating components enter the layers, the components start to react with hydroxide radicals (OH., HO₂. and H₂O₃.) and oxygen (O, O₂ and/or O₃) in radical chain reactions.

According to one non-limiting example, the radical chain reactions can include the following steps:

1) The Initiation Step:

In this step, the hydroxide radicals react with the contaminating components, thereby forming a radical R. of the contaminating component.

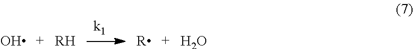

HO₂.+RH→R.+H₂O₂ (8)

2H₂O₃.+2RH→2R.+3H₂O₂, (9)

where RH is the organic compound of the contaminating component, and R. is the radical of the organic compound, i.e. the organic compound with an unpaired electron.

The rate k₁ of reaction (7) can be in the range of 10⁹ l/mol·s to 10¹⁰ l/mol·s. The Applicants found that the rates of reactions (8) and (9) are significantly lower than k₁. Accordingly, the role of the radicals R. obtained in these reactions can be neglected in the estimation of the radical chain reaction dynamics.

2) The Oxidation and Propagation Reaction Steps:

In these steps, the radical of the organic compound is oxidized by oxygen (reaction (10) to produce an oxidized radical ROO., to wit:

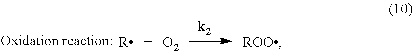

where k₂ can be in the range of about 10⁷ l/mol·s to about 10⁸ l/mol·s.

Thereafter, the oxidized radical ROO. reacts with another organic compound in a redox propagation reaction, to wit:

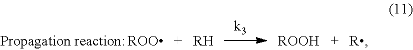

where k₃ can be in the range of about 2·10⁴ l/mol·s to about 2·10⁶ l/mol·s.

3) The Step of Branching of the Reaction Pathway:

In this step, the contaminating components are transformed into radical forms, in accordance with the following reaction:

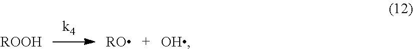

where k₄ can be in the range of about 10⁻⁷ l/mol·s to 3.5·10⁻⁶ l/mol·s.

Notwithstanding the very minor rate constant of this reaction, the branching step reveals an appearance of new OH. radicals which can initiate new chain reactions.

4) The Chain Termination Step:

In this step, the contaminant radicals (each having one unpaired electron) can react and bind together, i.e. to participate in heterocoagulation in accordance with reactions (13)-(15), thereby forming relatively large and heavy insoluble aggregates (212 in FIG. 2) that can precipitate to form sludge fluid, to wit:

R.+R.→R—R (13)

R.+ROO.→R—ROO (14)

ROO.+ROO.→ROO—ROO (15)

The constant rates of reactions (13)-(15) are around 10⁶ l/mol·s. The rate of these processes is controlled by the rates k₂ and k₃ of the propagation and oxidation reactions (10) and (11), respectively. It should be noted that the rates of reactions (10)-(15) depend on the concentrations of the radicals (R., and ROO.). The rate of the entire chain reaction formed by the sequence (7)-(15) is mainly limited by oxidation reaction (10), since the oxygen concentration in the process water-based fluid is limited by the oxygen dissolved in the fluid.

As was described above, a concentration of oxygen molecules in the singlet energy state should, preferably, be about three times greater than the concentration of oxygen molecules in the triplet energy state (this condition, hereinafter, will be referred to as “1:3 relation”). When the 1:3 relation is not met, the continuity of the chain reaction formed by the sequence (7)-(15) can be interrupted. In turn, the interruption of the continuity of the chain reaction can result in spontaneous formation of reactive, highly poisonous and carcinogenic compounds, such as halogen organic compounds, e.g., trihalomethanes.

In order to reach the desired 1:3 relation between the concentrations of energetically excited oxygen molecules, several physical parameters of the acoustic wave should be controlled. Examples of the physical parameters of the acoustic wave include, but are not limited to, the frequency, amplitude, intensity of the acoustic wave, and the time during which the fluid is exposed to the acoustic wave. Moreover, the magnitudes of the physical parameters of the acoustic wave chosen for the treatment depend on the flow rate of the process fluid and the chemical and/or electrochemical parameters of the process water-based fluid.

The 1:3 relation is explained by a level of activation of the oxygen molecules dissolved in the process water-based fluid located in the layers 21. Specifically, this relation is determined by a total energetic balance of the fluid that is formed in the layers 21 during the propagation of the acoustic wave. The Applicants believe that the total energetic balance of the fluid depends on the total concentration of hydroxide radicals which can be formed in the layers 21, the types of the hydroxide radicals, the rates of the reactions (1)-(7) and the products of these reactions. The 1:3 relation between the triplet to singlet oxygen concentrations can be monitored by various known techniques, such as cytopherometry, electronic spectrophotometry, various techniques measuring redox potentials and/or electric conductivity, etc. For monitoring purposes, when desired, the apparatus of the present invention can be equipped with the corresponding device(s) (not shown).

The total energetic balance of the process water-based fluid in the layers 21 can, for example, be determined on the basis of the changes of the concentration of any one of the hydroxide radicals. Preferably, radicals HO₂. can be used, since these radicals are highly reactive with molecular oxygen O₂ (see, for example reactions (4) and (6)). These reactions result in a significant increase of the fluid electric conductivity and in a significant change in the spectrum of the optic absorption of the fluid. For example, changes of the peaks of the bands 230 nanometers and 240 nanometers in the optic absorption are related to the changes of the concentration of HO₂. and O₂, respectively. The changes of the HO₂. concentration depend on the concentration of the oxygen molecules in the fluid and on the energetic state of the oxygen molecules.

It is believed by the Applicants that the 1:3 relation between the triplet to singlet oxygen concentrations corresponds to an optimal condition for trapping radicals dissolved in the fluid, and thereby provides maximal reactivity of the HO₂. radicals. The applicants found that a maximal output of the radicals can be increased from a value of about 15 ions per 100 eV (that corresponds to the case of uncontrolled oxygen activation) to the value of about 120 ions per 100 eV (when the 1:3 relation is fulfilled). A control of the changes of the concentration of radicals HO₂. can, for example, be provided by measuring the changes of the concentrations of hydrogen in radicals. For example, this concentration should be about 0.1 mol/l.

It was found by the Applicant that the increase of oxygen concentration in the fluid under the acoustic wave treatment should not exceed a predetermined value that, inter alia, depends on the quality of the treated fluid. For example, when the oxygen concentration exceeds the predetermined value and the 1:3 relation is disturbed, the maximal output of the radicals can drop down from about 120 ions per 100 eV to the value of about 5 ions per 100 eV or even less.

Turning back to FIG. 1, in operation, the inlet sensing assembly 172 measures chemical and/or electro-chemical properties of the process water-based fluid. As described above, examples of the electro-chemical properties include, but are not limited to, pH, zeta potential, gamma potential, redox potential and electrical conductivity of the fluid. In turn, examples of the chemical properties include, but are not limited to, total suspended solids (TSS), concentration, total organic content (TOC), color index, total hardness, carbonate hardness, oxidizability, iron concentration, dissolved oxygen concentration, ammonia concentration, nitrite concentration, nitrate concentration, fluorine concentration, manganese concentration, silicium concentration, carbon dioxide concentration, sulfate concentration, chloride concentration, alkalinity, and dry residue content.

Magnitudes of the measured chemical and/or electro-chemical properties of the fluid are provided to the controller 171 together with the required magnitudes of the properties which the fluid should obtain after the treatment. The required magnitudes of the chemical and/or electro-chemical properties can, for example be selected in accordance with the World Health Organization (WHO) standards for drinking water.

In operation, the controller 171 analyzes these data and generates control signals to control, inter alia, operation of the acoustic vibrator 16. According to one embodiment, the analysis of the data by the controller 171 includes calculation of the acoustic wave parameters. In the first approximation, a look-up calibration table establishing a relationship between the chemical and/or electro-chemical properties and the acoustic wave parameters can be used for tuning the acoustic vibrator 16.

An example of such a look-up table is shown in Table 1. In accordance with Table 1, any parameter selected from TSS, TOC and Redox potential can be selected for obtaining the corresponding frequency, amplitude, intensity of the acoustic wave, and the time during which the fluid should be exposed to the acoustic wave. It should be understood that various approximation algorithms can be employed for calculation of more precise values of the wave parameters.

TABLE 1
Look-up calibration table establishing a relationship between the chemical
and/or electro-chemical properties and the acoustic wave parameters

| Process water- | | | | | | |
|---|---|---|---|---|---|---|
| based fluid | | | Parameters of the acoustic vibrator | | | |
| characteristics | | Redox | Fre- | | | |
| TSS | TOC | Potential | quency | Intensity | Amplitude | Time |
| (mg/l) | (mg/l) | (mV) | (kHz) | (W/cm²⁾ | (μm) | (sec) |
| 0.5 | 1.75 | −4.82 | 28.0 | 0.80 | 1.0 | 4-6 |
| 1.0 | 2.37 | −5.01 | 25.0 | 1.10 | 1.5 | 5-8 |
| 1.5 | 2.56 | −5.04 | 23.0 | 1.35 | 2.0 | 6-9 |
| 10.0 | 4.31 | −5.08 | 35.0 | 2.00 | 3.0 | 12-20 |
| 20.0 | 5.87 | −5.12 | 40.0 | 2.50 | 2.9 | 30-60 |
| 30.0 | 6.97 | −5.27 | 40.0 | 3.00 | 3.1 | 9-180 |

For the calculation of the precise values, known physical relationships between the wave parameters can be used. Specifically, the acoustic energy W can be estimated as a sum of a kinetic energy of the oscillating region and a potential energy of the elastic deformation of the acoustic environment. An intensity I of an acoustic wave propagating through an area S can be defined as an acoustic energy W divided by the area S and the propagation time t, to wit:

I=W/(S·t).

In turn, the intensity I of acoustic wave depends on the oscillation amplitude A, value of an alternating acoustic pressure and the velocity V of the oscillating elements. A relationship between the acoustic intensity I and the amplitude A can be obtained by:

I=(ρ·C·ω²·A²)/2

where ρ is the environmental density, C is the propagation speed of the acoustic wave (sound speed), ω is the angular frequency, and A is the oscillated amplitude. Further, a relationship between the intensity I and the alternating acoustic pressure P can be determined as I=P/(2·ρ·C). Finally, a relationship between the acoustic intensity I and the velocity V of the oscillating elements is obtained by I=(ρ·C·V²)/2.

A power N of an acoustic generator can be obtained by the multiplication of the acoustic intensity I by the emitting area T of the emitting head of the acoustic generator, to wit: N=I·T. The energy adsorbed by a volume V of the environment is defined as a physical dose D. The dose D can be obtained by D=(I·t·S)/V, where I is the acoustic intensity, S is the area exposed to the acoustic wave and t is the time of exposing the volume V to the acoustic wave. It should be noted that the dose D estimated in accordance with the relation described above is an averaged value of the dose; whereas the value of the dose in some specific areas can differ from the average value owing to a non-uniform distribution of the acoustic energy in the environment.

Moreover, it should be noted that during the acoustic wave propagation the intensity I of the acoustic wave decreases as a function of distance from the emitting source in accordance with the following relationship:

I=I₀·e^{-2ax},

where I₀ is the initial acoustic intensity, x is the distance from the emitting source, and a is the coefficient of acoustic absorption in the environment.

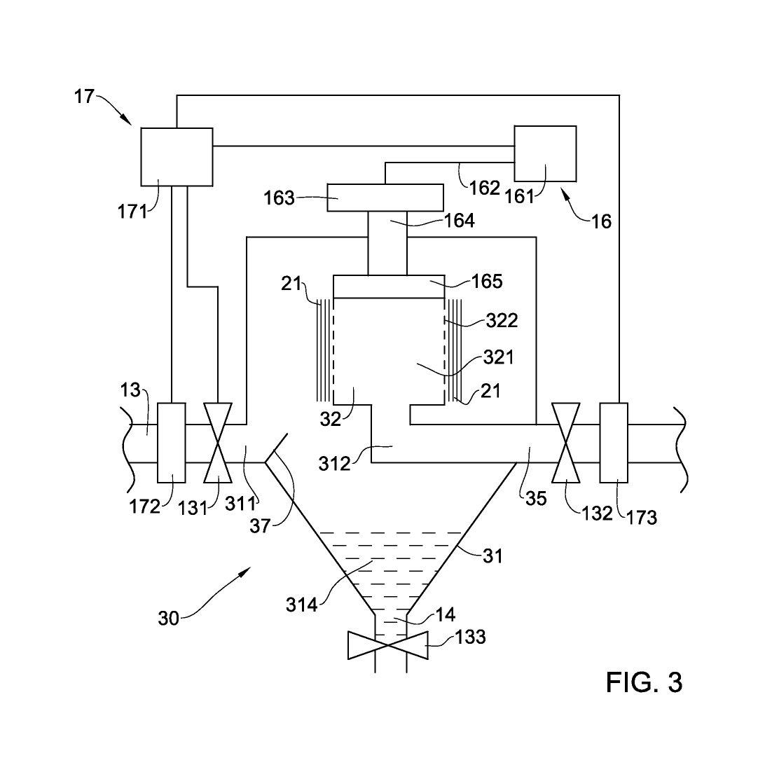

Referring to FIG. 3, there is provided a schematic view of an apparatus 30 for separation of a purified fluid from a process water-based fluid containing one or more contaminating components, according to another embodiment of the present invention. The apparatus 30 includes a housing 31, the acoustic wave vibrator 16 adapted for generating acoustic waves within the process water-based fluid in the housing 31, and a filter unit 32 disposed in the housing 31 for filtering the pre-filtered water-based fluid obtained after passing the process water-based fluid through the layers 21 formed by the acoustic wave vibrator 16. The housing 31 includes an inlet port 311 for receiving the process water-based fluid, and a sludge port 314 for discharge of the sludge fluid.

In operation, the process water-based fluid flows through the inlet pipe 13, and enters the housing 31 through the inlet port 311. After a separation procedure, as will be described thereinafter, the purified fluid flows out of the housing 31 through the outlet port 312 into an outlet pipe 35. The sludge fluid is collected from the sludge port 314 and fed into the sludge-collection pipe 14. When desired, the sludge-collection pipe 14 can be associated with a wastewater system (not shown) where the sludge fluid can be treated as described hereinbefore.

Preferably, the controllable inlet valve 131, the controllable outlet valve 132 and the controllable sludge valve 133 are disposed in the vicinity of the inlet port 311, the outlet port 312 and the sludge port 313, respectively.

The acoustic wave vibrator 16 is configured and operable for generating a controllable acoustic wave. According to one embodiment of the present invention, the acoustic wave vibrator 16 includes a generator 161, a transducer 163 coupled to the generator 161 via a connecting line 162, and a vibrating element 165 coupled to the transducer 163 via a transmitting line 164. The vibrating element 165 is associated with the filter unit 32 for vibrating the filter unit. The configuration and principles of operation of the acoustic vibrator 16 and its components (161-165 in FIG. 1) are described above with reference to FIG. 1.

According to one embodiment, the vibrating element 165 is mechanically attached to the filter unit 32 so it can participate in vibrations together with the vibrating element 165 and produce acoustic waves within the process water-based fluid. As was described above with reference to FIG. 2, the acoustic waves can create the layers 21 within the fluid that have an increased second viscosity, when compared to the viscosity of the process water-based fluid at the inlet port. According to this embodiment, the layers 21 can be formed in the vicinity of the filter unit 32, and include hydroxide radicals and various forms of oxygen that can oxidize the contaminating components, and thereby cause their coagulation. Consequently, the process water-based fluid, after passing through these layers, is divided into a pre-filtered fluid and a sludge fluid.

As described above, the filter unit 32 is disposed in the flow of the pre-filtered fluid downstream of the layers 21. The filter unit 32 is configured and operated for filtering and separation of contaminating components in the pre-filtered fluid which are left after passing the process water-based fluid through the layers.

According to the embodiment shown in FIG. 3, the filter unit 32 is a tubular filter disposed within the housing 31 in the flow of the pre-filtered fluid. The flow of the pre-filtered fluid passes into an inner space 321 of the tubular body of the filter unit through filtering walls 322. The filtering walls 322 can, for example, include pores for impeding passage of the contaminating components remaining after passing the fluid through the layers 21 thereby obtaining the purified fluid inside the filter unit 32. Further, the purified fluid flows out from the filter unit 32 to the outlet pipe 312 coupled to the filter unit 32 for discharge of the purified fluid.

It should be understood that the filter unit 32 is not limited to any particular implementation. Examples of the filter units include, but are not limited to, one or more filters selected from single media filters, multi-media filters, diatomaceous earth filters, cartridge filters, membrane filters, granular filters, etc. When desired, any combination of the filters of various types can be used.

According to a further embodiment, the housing 31 includes a flow damper 37 disposed within the flow of the process water-based fluid downstream of the inlet port 111. The flow damper 19 can include any flow control unit (not shown) that is configured and operable to produce a substantially laminar flow of the process water-based fluid through the housing on the macroscopic scale level.

According to a further embodiment, the apparatus 30 comprises a control system 17 configured for controlling the operation of the acoustic vibrator 16, the inlet valve 131 and/or the outlet valve 132, as described above with reference to the embodiment shown in FIG. 1. The configuration and principles of operation of the control system 17 and its components (171-173 in FIG. 1) are described above with reference to FIG. 1.

### EXAMPLES

The essence of the present invention can be better understood from the following non-limiting examples which are intended to illustrate the present invention and to teach a person of the art how to make and use the invention. These examples are not intended to limit the scope of the invention or its protection in any way.

### Example 1

Process water from Geneva Lake probed in Geneva (Switzerland) was treated by the method and apparatus, according to one embodiment of the present invention. No preliminary mechanical, physicochemical or biological purification of the process water was performed in the treatment. The acoustic wave parameters of the apparatus were set as follows: the frequency of the acoustic wave was 15.3 kHz, the amplitude of the acoustic wave was 1.2 micrometers, the intensity of the acoustic wave was 0.72 Watt/cm² and the treatment time was 0.03 seconds.

The chemical and electro-chemical properties of the process water and the pre-filtered fluid obtained after passing through the layers formed by the acoustic wave (before filtration with a filter unit) are presented in Table 2.

TABLE 2
Exemplary chemical and electro-chemical properties of the probed
process water and the pre-filtered fluid obtained by a method and
apparatus of the present invention in accordance with one embodiment

| | | Process | Pre-filtered |
|---|---|---|---|
| No | Item | fluid, mg/l | fluid, mg/l |
| 1 | Total suspended solids (TSS), mg/l | 30 | 0.6 |
| 2 | Color index, deg | 45 | 17 |
| 3 | pH | 7.05 | 7.13 |
| 4 | Total hardness, mEq/l | 5.35 | 5.35 |
| 5 | Carbonate hardness, microEqu/l | 4.8 | 4.8 |
| 6 | Oxidizability, O₂ mg/l | 8.5 | 6.1 |
| 7 | Total iron, mg/l | 0.25 | 0.12 |
| 8 | Dissolved Oxygen, mg/l | 8.0 | 4.92 |
| 9 | Ammonia, mg/l | 1.2 | 1.2 |
| 10 | Nitrites, mg/l | 0.001 | 0.001 |
| 11 | Nitrates, mg/l | 1.5 | 1.5 |
| 12 | Alkalinity, mg * Eq/l | 4.0 | 3.57 |
| 13 | Fluorine, mg/l | 0.55 | 0.55 |
| 14 | Manganese, mg/l | 0.02 | 0.02 |
| 15 | Silicium, mg/l | 2.0 | 1.81 |
| 16 | Carbon dioxide, mg/l | 6.5 | 3.62 |
| 17 | Sulfates, mg/l | 81.0 | 81.0 |
| 18 | Chlorides, mg/l | 22.0 | 22.0 |
| 19 | Dry residue, mg/l | 438.0 | 217.0 |

As can be seen from Example 1, the treatment of the probed water results in essential reduction of the concentration of contaminating components (e.g., TSS changes from 30 mg/l to 0.6 mg/l) and dissolved gases (e.g., concentration of oxygen changes from 8 mg/l to 4.92 mg/l).

### Example 2

Process water from Vltava River probed in Prague (Czech Republic) was treated by the same method and apparatus that was used in Example 1. No preliminary mechanical, physicochemical or biological purification of the process water was performed in the treatment. The acoustic wave parameters of the apparatus were set as follows: the frequency of the acoustic wave was 22 kHz, the amplitude of the acoustic wave was 2 micrometers, the intensity of the acoustic wave was 1 Watt/cm² and the treatment time was 2 seconds.

The parameters of the process water-based fluid and pre-filtered fluid are presented in Table 3.

TABLE 3
Exemplary chemical and electro-chemical properties of the probed
process water and the pre-filtered fluid obtained by a method and
apparatus of the present invention in accordance with one embodiment

| | | Process | Pre-filtered |
|---|---|---|---|
| No | Item | fluid, mg/l | fluid, mg/l |
| 1 | Total suspended solids, mg/l | 65 | 1.2 |
| 2 | Color index, deg | 51 | 18 |
| 3 | pH | 7.2 | 7.39 |
| 4 | Total hardness, mEq/l | 0.9 | 0.9 |
| 5 | Carbonate hardness, microEqu/l | 0.8 | 0.8 |
| 6 | Oxidizability, O₂ mg/l | 12.5 | 7.2 |
| 7 | Total iron, mg/l | 0.4 | 0.16 |
| 8 | Dissolved Oxygen, mg/l | 7.3 | 3.45 |
| 9 | Ammonia, mg/l | 2.5 | 2.5 |
| 10 | Nitrites, mg/l | 0.005 | 0.005 |
| 11 | Nitrates, mg/l | 5.6 | 5.6 |
| 12 | Alkalinity, mg * Eq/l | 0.8 | 0.2 |
| 13 | Fluorine, mg/l | 0.76 | 0.76 |
| 14 | Manganese, mg/l | 0.1 | 0.1 |
| 15 | Silicium, mg/l | 8.3 | 8.0 |
| 16 | Carbon dioxide, mg/l | 3.0 | 1.9 |
| 17 | Sulfates, mg/l | 4.2 | 4.2 |
| 18 | Chlorides, mg/l | 3.8 | 3.8 |
| 19 | Dry residue, mg/l | 66.0 | 47.0 |

As can be seen from Example 2, the treatment of the probed water results in essential reduction of the concentration of contaminating components (e.g., TSS changes from 65 mg/l to 1.2 mg/l) and dissolved gases (e.g., concentration of oxygen changes from 7.3 mg/l to 3.45 mg/l).

It should be noted that the apparatus of the present invention may be employed only when the chemical and electrochemical properties of the fluid under treatment are within a certain predetermined range of values. Otherwise, a pre-treatment of the process water-based fluid can be required. Specifically, the pre-treatment of the process water-based fluid can involve predetermined mechanical, physicochemical and/or biological treatment required for adjusting the chemical and electrochemical properties so they would fall within the predetermined range of values. The pre-treatment can include flocculation, aggregation, coagulation, oxidation, alkalization, disinfection, preservation, degasification, filtration of the suspended contaminating components and other processes.

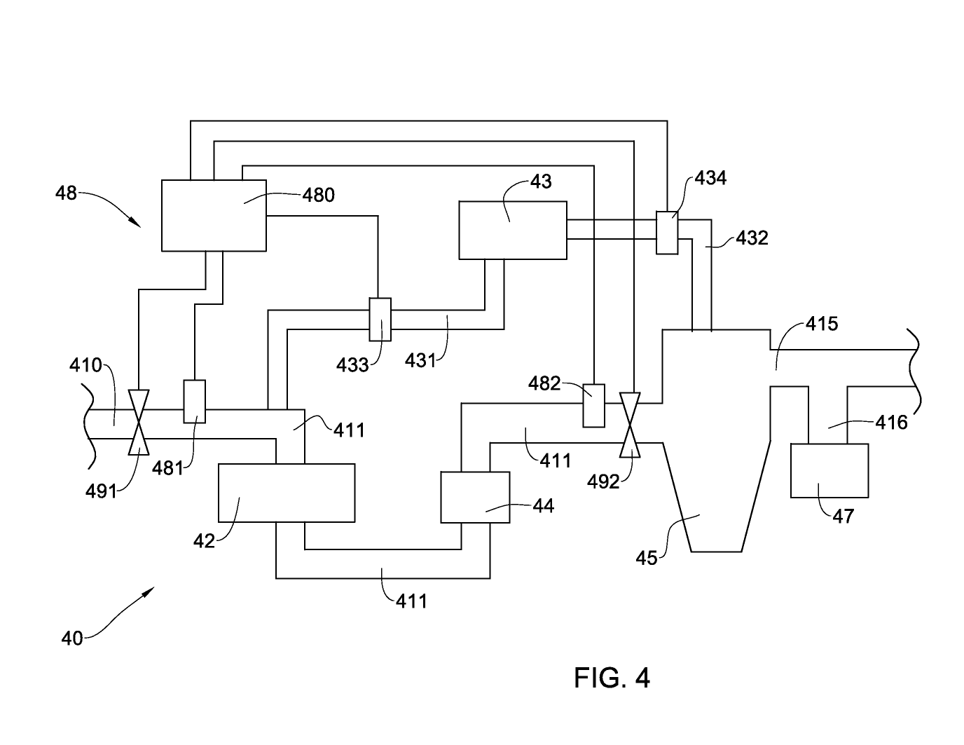

Referring now to FIG. 4, there is schematically illustrated a non-limiting example of a system 40 for treatment of the process water-based fluid employing pre-treatment. The system 40 includes a manifold 411 having an inlet port 410 for receiving the process water-based fluid and an outlet port 415 for discharging the purified fluid. For the purpose of pre-treatment, the system 40 includes a flocculation unit 42 configured for agglomeration of the contaminating components to produce buoyant floc, and a pressure filter 44 configured for a pre-filtration of the process water-based fluid. Finally, the system 40 includes an apparatus 45 for separation of a purified fluid from a process water-based fluid that should be configured and operable according to any one of the embodiments described above and shown in FIGS. 1-3.

In operation, the process water-based fluid ingresses through the inlet port 410 into the manifold 411, and after an entire treatment procedure, the purified fluid egresses from the manifold 411 through the outlet port 415 and can be delivered to a consumer (not shown). When desired, the purified fluid can be discharged into a collecting tank 47 through a collecting pipe 416.

The flocculation unit 42 can, for example, be used for agglomeration of the contaminating components containing heavy metals. The flocculation unit 42 is arranged within the manifold 411 in a flow of the process water-based fluid. The flocculation unit 42 can be a known apparatus configured for and operable to introduce an effective amount of various flocculating chemicals into the process water-based fluid in order to produce buoyant floc that incorporates the contaminating components. Examples of the flocculating chemicals that can be introduced into the process water-based fluid include, but are not limited to, metal salts, metal scavengers and flocculating polymers. For instance, the metal salt can be an aluminum salt. The metal scavengers can, for example, include metal sulfides, metal carbonates, metal thiocarbonates, metal thiocarbamate, mercaptans and combinations thereof. An example of the flocculating polymer includes, but is not limited to, an ethylene dichloride ammonia polymer.

The pressure filter 44 is configured and operable for a pressure pre-filtration of the process water-based fluid. According to the embodiment shown in FIG. 4, the pressure filter 44 is disposed in the flow of the process water-based fluid downstream of the flocculation unit 42. The pressure filter 44 is a known device which can provide an elevated pressure at the entrance of the filter. The use of pressure filter 44 can be required for the treatment of the process water-based fluid containing extremely high concentrations of the contaminating components in the form of suspended solids and emulsified liquids, such as hydrocarbons, oils and greases.

According to one embodiment shown in FIG. 4, the system 40 includes a control system 48 coupled to a controllable inlet valve 491 and a controllable process valve 492, and configured for controlling operation thereof. The control system 48 can be adjusted either automatically or manually to control operation of the controllable inlet valve 491 and the controllable process valve 492 to regulate flow rate of an original process water-based fluid and a pre-treated process water-based fluid, respectively.

According to one embodiment, the control system 48 includes a controller 480, an inlet sensing assembly 481 coupled to the controller 480, and a pre-treatment sensing assembly 482 coupled to the controller 480. The controller 480 is an electronic device that can, inter alia, generate control signals to control operation of the controllable inlet valve 491 and/or the controllable process valve 492.

The inlet sensing assembly 481 is arranged at the inlet port 410 of the manifold 411 and configured for measuring the chemical and/or electro-chemical properties of the original process water-based fluid. The pre-treatment sensing assembly 482 is arranged within the flow of the pre-treated fluid upstream of the apparatus 45. The pre-treatment sensing assembly 482 is configured for measuring the properties of the process water-based fluid after the preliminary treatment by the flocculation unit 42 and the pressure filter 44. The sensing assemblies 481 and 482 can include one or more chemical and/or electro-chemical sensors configured for measuring of chemical and/or electro-chemical properties of the process water-based fluid and generating inlet and pre-treated sensor signals indicative of the fluid properties. The inlet and pre-treated sensor signals can be relayed to the controller 480 via a connecting wire or wirelessly.

Examples of the electro-chemical properties include, but are not limited to, pH, zeta potential, gamma potential, redox potential and electrical conductivity of the fluid. In turn, examples of the chemical properties include, but are not limited to, total suspended solids (TSS) concentration, total organic content (TOC), color index, total hardness, carbonate hardness, oxidizability, iron concentration, dissolved oxygen concentration, ammonia concentration, nitrite concentration, nitrate concentration, fluorine concentration, manganese concentration, silicium concentration, carbon dioxide concentration, sulfate concentration, chloride concentration, alkalinity, and dry residue content.

When desired to enhance the fluid treatment, the system 40 can further include a reagent tank 43 coupled to the manifold 411 and configured to supply additional chemical reagents in the process water-based fluid, as will be described below. Examples of the chemical reagents contain, but are not limited to, coagulants, flocculants, oxidants, acids, bases, disinfectants, preservative agents and deodorants in various combinations.

According to the embodiment shown in FIG. 4, these reagents can be supplied into the manifold 411 via a dosing pipe 431 or directly into the apparatus 45 via a dosing pump 432. The supply of the reagents in the manifold 411 and in the apparatus 45 can be controlled by reagent supply valves 433 and 434, respectively. The supply of the reagents can be controlled by the control system 48. In this case, the control system 48 can be coupled to the reagent tank 43 and/or to the supply valves 433 and 434. In operation, the control system 48 is responsive to the inlet and pre-treated sensor signals produced by the sensing assemblies 481-482, and is configured to generate inlet and pre-treated control signals to the supply valves 433 and/or 434 for controlling the release of the chemical reagents from the reagent tank 43 therethrough, respectively.

The method, apparatus and system of the present invention have many of the advantages of the techniques mentioned theretofore, while simultaneously overcoming some of the disadvantages normally associated therewith.

The method and apparatus of the present invention is highly economical and operates with minimal losses of energy and chemicals. It is believed by the inventors that the technique of present invention allows reducing a total amount of chemical reagents utilized during the treatment of fluids, when compared to operation of conventional systems known in the art. For example, the method of the present invention allows increasing the capabilities of contaminating components to coagulate and flocculate, and thereby to decrease the amount of the coagulative reagents required for the fluid treatment, when compared to conventional techniques.

For example, when aluminum hydroxide (Al(OH)₃) or ferric hydroxide (Fe(OH)₃) are used for coagulation of contaminating components, the method and apparatus of the present invention allows lessening the time of the wastewater treatment by half.

Due to the fact that most of the contaminating components are settled down as sludge before reaching the filter, the method and apparatus of the present invention prolongs effective working time and exploitation efficiency of filter units utilized with the fluid treatment systems. Moreover, the waste of water and cleaning reagents used for flushing the filters can be significantly decreased. In addition, the technique of the present invention allows passage of process fluid through the filter at higher rates, thereby to augment the efficiency of the fluid purification process.

It should be noted that the method and apparatus of the present invention can be applied for disinfection of the process water-based fluid. The term ‘disinfection’ is construed here in a broad meaning and is related to a process where a significant percentage of pathogenic organisms are killed or controlled. The disinfection of the process fluid provides a degree of protection from contact with pathogenic organisms including those causing cholera, polio, typhoid, hepatitis and a number of other bacterial, viral and parasitic diseases.

The apparatus and method of the present invention may be suitable for effective treatment of any water-based fluid from suspended contaminating components such as oil products, detergents, phenols, dyes, complexons, complexonates, aromatic compounds, unsaturated organic compounds, aldehydes, organic acids, polymers, hydrosols, biological particles and colloidal matter.

The apparatus and method of the present invention may be suitable, for example, for any private or industrial application requiring treatment of any water-based fluid including groundwater, surface water, wastewater, industrial effluent, municipal sewage, sewerage, recycled water, tertiary wastewater, landfill leachate, saline water, milk, wine, beer and juice.

Also, it is to be understood that the phraseology and terminology employed herein are for the purpose of description and should not be regarded as limiting.

Finally, it should be noted that the word “comprising” as used throughout the appended claims is to be interpreted to mean “including but not limited to”.

It is important, therefore, that the scope of the invention is not construed as being limited by the illustrative embodiments set forth herein. Other variations are possible within the scope of the present invention as defined in the appended claims. Other combinations and sub-combinations of features, functions, elements and/or properties may be claimed through amendment of the present claims or presentation of new claims in this or a related application. Such amended or new claims, whether they are directed to different combinations or directed to the same combinations, whether different, broader, narrower or equal in scope to the original claims, are also regarded as included within the subject matter of the present description.

1. An apparatus for controllable separation of a purified fluid from a process water-based fluid containing at least one contaminating component, comprising:
a housing having an inlet port for receiving the process water-based fluid through a controllable inlet valve arranged at the inlet port and regulating a flow rate of said process water-based fluid, an outlet port for release of the purified fluid and a sludge port for discharge of a sludge fluid;
an acoustic vibrator configured for generating a controllable acoustic wave having at least one adjustable parameter selected from frequency, amplitude, intensity; wherein said acoustic wave creates at least one layer in the process water-based fluid dividing the process water-based fluid into a pre-filtered fluid and the sludge fluid; said at least one layer is substantially perpendicular to a flow direction of said process water-based fluid, and comprises hydroxide radicals and oxygen species including oxygen molecules in a singlet energy state and oxygen molecules in a triplet energy state reacting with said at least one contaminating component, thereby transforming the component into radical form and oxidizing it thereby causing binding of the component into insoluble aggregates which are precipitated within the sludge fluid; wherein at least one adjustable parameter is adjusted to provide such activation of oxygen species that a concentration of the oxygen molecules being in the singlet energy state is about three times greater than the concentration of the oxygen molecules being in the triplet energy state; and
a filter unit disposed within said housing in a flow of the pre-filtered fluid from said at least one layer to said outlet port.

2. The apparatus of claim 1, comprising a control system connected to the inlet valve and to the acoustic vibrator and configured for controlling operation thereof, wherein said control system comprises:
an inlet sensing assembly including at least one sensor mounted at the inlet port and configured for measuring at least one inlet electro-chemical characteristic of the process water-based fluid and producing at least one inlet sensor signal indicative of said at least one inlet electro-chemical characteristic; said at least one sensor is configured for measuring at least one inlet chemical characteristic of the process water-based fluid and producing at least one inlet sensor signal indicative of said at least one inlet chemical characteristic;
a controller operatively coupled to the acoustic vibrator and to said at least one sensor and to the inlet valve, the controller being responsive to said at least one inlet sensor signal and being capable of generating control signals for controlling operation of said acoustic vibrator and said inlet valve.

3. The apparatus of claim 2, wherein said at least one inlet electro-chemical characteristic is selected from pH, zeta potential, gamma potential, redox potential and electrical conductivity; and wherein said at least one inlet chemical characteristic is selected from an amount of total suspended solids, total organic content, color index, total hardness, carbonate hardness, oxidizability, iron concentration, dissolved oxygen concentration, ammonia concentration, nitrite concentration, nitrate concentration, alkalinity, fluorine concentration, manganese concentration, silicium concentration, carbon dioxide concentration, sulfate concentration, chloride concentration and dry residue content.

4. The apparatus of claim 1, wherein said at least one adjustable parameter of said controllable acoustic wave and the flow rate downstream of the inlet valve are calculated by using look-up tables for the controllable separation of the purified fluid.

5. The apparatus of claim 2, wherein the control system comprises an outlet sensing assembly including at least one sensor mounted at the outlet port and configured for measuring at least one outlet electro-chemical characteristic of the purified fluid and for producing at least one outlet sensor signal indicative of said at least one outlet electro-chemical characteristic; said at least one sensor is configured for measuring at least one outlet chemical characteristic of the purified water-based fluid and producing at least one outlet sensor signal indicative of said at least one outlet chemical characteristic; said outlet sensing assembly being operatively coupled to the controller, the controller being responsive to said at least one outlet sensor signal.

6. The apparatus according to claim 5, wherein said at least one outlet electro-chemical characteristic is selected from pH, zeta potential, gamma potential, redox potential and electrical conductivity; and wherein said at least one outlet chemical characteristic is selected from an amount of total suspended solids, total organic content, color index, total hardness, carbonate hardness, oxidizability, iron concentration, dissolved oxygen concentration, ammonia concentration, nitrite concentration, nitrate concentration, alkalinity, fluorine concentration, manganese concentration, silicium concentration, carbon dioxide concentration, sulfate concentration, chloride concentration and dry residue content.

7. The apparatus of claim 1, comprising a flow damper disposed in the flow of the process water-based fluid between said inlet port and the filter unit, and configured for providing a substantially laminar flow of said process water-based fluid.

8. The apparatus of claim 1, wherein said acoustic vibrator is coupled to the filter unit for vibrating thereof, thereby creating said at least one layer of high viscosity in the vicinity of the filter unit; said at least one layer having an increased value for second viscosity when compared with the value of the viscosity of the process water-based fluid at the inlet port.

9. The apparatus of claim 1, wherein said acoustic vibrator includes a vibrating membrane mounted in the flow of the process water-based fluid upstream of the filter unit for creating said at least one layer of high viscosity in the vicinity of said vibrating membrane; said at least one layer having an increased value for second viscosity when compared with the value of the viscosity of the process water-based fluid at the inlet port.

10. The apparatus of claim 1 having such a configuration so as to create a standing acoustic wave within the process water-based fluid.

11. The apparatus of claim 1, wherein the process water-based fluid is selected from groundwater, surface water, wastewater, industrial effluent, municipal sewage, sewerage, recycled water, tertiary wastewater, landfill leachate, saline water, milk, wine, beer, juice and combinations thereof; and wherein said at least one contaminating component is an organic contaminating component selected from oil products, detergents, phenols, dyes, complexons, complexonates, aromatic compounds, unsaturated organic compounds, aldehydes, organic acids, polymers, hydrosols, biological particles and colloidal matter.

12. The apparatus of claim 1, wherein said acoustic vibrator includes a piezo active element.

13. The apparatus of claim 1, wherein said filter unit includes at least one filter selected from a single media filter, a multi-media filter, a diatomaceous earth filter, a cartridge filter, a membrane filter and a granular filter.

14. A method for controllable separation of a purified fluid from a process water-based fluid containing at least one contaminating component, comprising:
providing an apparatus including a housing having an inlet port for receiving the process water-based fluid through a controllable inlet valve arranged at the inlet port and regulating a flow rate of said process water-based fluid, an outlet port for release of the purified fluid and a sludge port for discharge of a sludge fluid, a filter unit and an acoustic vibrator;
providing a flow of the process water-based fluid into the housing through said controllable inlet valve and maintaining a substantially laminar flow of the process water-based fluid within the housing;
generating an acoustic wave for creating at least one layer in the process water-based fluid thereby dividing the process water-based fluid into a pre-filtered fluid and the sludge fluid, said acoustic wave having at least one adjustable parameter selected from frequency, amplitude, and intensity; said at least one layer is substantially perpendicular to a flow direction of said process water-based fluid and comprises hydroxide radicals and oxygen species reacting with said at least one contaminating component thereby transforming the component into radical form and oxidizing the component thereby causing binding of the contaminating component into insoluble aggregates which are precipitated within the sludge fluid; wherein said generating of the acoustic wave includes adjusting said at least one adjustable parameter in order to activate the oxygen species such that a concentration of oxygen molecules in a singlet energy state is about three times greater than the concentration of oxygen molecules in a triplet energy state;
directing a flow of the pre-filtered fluid through the filter unit to obtain the purified fluid downstream of the filter unit;
releasing the purified fluid from the housing through the outlet port; and
discharging the sludge fluid from the housing through the sludge port.

15. The method of claim 14 comprising controlling operation of the inlet valve and the acoustic vibrator, wherein said controlling of operation of the inlet valve and the acoustic vibrator includes:
measuring at least one of zeta potential, gamma potential, redox potential and electrical conductivity of the process water-based fluid at the inlet port;
calculating said at least one adjustable parameter of the controllable acoustic wave and the flow rate downstream of the inlet valve by using look-up tables for the controllable separation of the purified fluid; and
regulating at least one wave parameter selected from frequency, amplitude, intensity of the acoustic wave produced by the acoustic vibrator and the flow rate of the process water-based fluid downstream of the inlet valve to match values of the wave parameters and the flow rate obtained in said calculating.

16. The method of claim 14, comprising generating standing acoustic waves within the process water-based fluid in the housing.

17. The method of claim 14, wherein a frequency of the acoustic wave is in the range of about 15 kHz to about 300 kHz; an amplitude of the acoustic wave is in the range of about 1 micrometer to about 10 micrometers; and an intensity of the acoustic wave is in the range of about 0.1 W/cm² to about 10 W/cm².

18. The method of claim 14, wherein said at least one layer features an increased value of a second viscosity when compared with the viscosity of the process water-based fluid at the inlet port.

19. The method of claim 14, wherein said at least one contaminating component is an organic contaminating component selected from oil products, detergents, phenols, dyes, complexons, complexonates, aromatic compounds, unsaturated organic compounds, aldehydes, organic acids, polymers, hydrosols, biological particles and colloidal matter.

20. A method for controllable separation of a purified fluid from a process water-based fluid containing at least one contaminating component, comprising:
passing said process water-based fluid through at least one layer formed in the process water-based fluid generated by an acoustic wave to divide the process water-based fluid into a pre-filtered fluid and a sludge fluid, said at least one layer comprising hydroxide radicals and oxygen species to react with and oxidize said at least one contaminating component and transforming the component into insoluble aggregates, wherein said oxygen species include oxygen molecules in a singlet energy state and oxygen molecules in a triplet energy state; a concentration of the oxygen molecules being in the singlet energy state is about three times greater than the concentration of oxygen molecules being in the triplet energy state; and
passing said pre-filtered fluid through a filter unit to obtain the purified fluid downstream of the filter unit.
